(19) United States
(12) Patent Application Publication
(10) Pub. No.: US 2008/0047116 A1
(43) Pub. Date: Feb. 28, 2008

(54) METHOD OF PRODUCING ELECTROLYTIC CAPACITOR

(75) Inventors: Kazuhiro TAKATANI, Osaka (JP); Takahisa Iida, Tottori-city (JP); Takashi Umemoto, Osaka (JP); Hiroshi Nonoue, Osaka (JP)

Correspondence Address: DITTHAVONG MORI & STEINER, P.C., 918 Prince St., Alexandria, VA, 22314, US

(73) Assignee: Sanyo Electric Co., Ltd., Moriguchi-city (JP)

(21) Appl. No.: 11/828,045

(22) Filed: Jul. 25, 2007

(30) Foreign Application Priority Data
Jul. 27, 2006 (JP) 2006-205359

(51) Int. Cl. H01G 9/00; H01G 9/15

(52) U.S. Cl. 29/25.03

(57) ABSTRACT

Provided is a method of producing an electrolytic capacitor being higher in capacitance, lower in leakage current, and difficult to deteriorate these properties even when processed in a heat-treatment process such as reflow soldering process. In the method of producing a solid electrolytic capacitor, firstly, an anode containing a valve metal is prepared. Then, the anode is anodized in an aqueous solution of 0.1% by weight of ammonium hexafluorosilicate to form a dielectric layer on the surface of the anode. An electrolyte layer of polypyrrole is formed on the dielectric layer, and further a cathode is formed on the electrolyte layer. Subsequently, an anode lead is connected to the anode and a cathode lead is connected to the cathode, and these are covered with a resin layer of an epoxy resin.

### BACKGROUND OF THE INVENTION

1. Field of the Invention

The present invention relates to a method of producing an electrolytic capacitor.

2. Description of the Related Art

In general, solid electrolytic capacitors have an anode of a valve metal such as titanium, niobium, or tantalum or an alloy containing the valve metal as a main component, a dielectric layer of an oxide of the valve metal formed on a surface of the anode, a solid electrolyte layer of a conductive oxide or a conductive polymer formed on the dielectric layer, and a cathode including a carbon layer and a silver paint layer formed on the solid electrolyte layer. The dielectric layer is formed by anodizing the anode in an electrolyte solution such as aqueous phosphate solution (see, for example, Japanese Patent Laid-Open Nos. 6-151258 and 2004-18966).

However, a dielectric layer of an oxide of the above-mentioned valve metal is vulnerable to heat, and, in particular, a dielectric layer formed by anodizing an anode of niobium or titanium has a problem of being more vulnerable to heat. Thus, conventional solid electrolytic capacitors have a problem of increasing leakage current by cracking in and crystallization of the dielectric layer induced by expansion and contraction of the electrolyte layer in a heat-treatment process such as a reflow soldering process.

In recent years, a solid electrolytic capacitor having an anode of niobium, and having a dielectric layer including a niobium oxide layer and a niobium nitride region formed on the surface of the anode for prevention of the change in capacitance by heating in the reflow soldering process has been proposed (see, for example, Japanese Patent Laid-Open No. 11-329902).

However, as described above, there has remained the problem that the leakage current increases, since it is not possible to sufficiently prevent the cracking in the dielectric layer and the crystallization of the dielectric layer in a heat-treatment process such as a reflow soldering process, even with the solid electrolytic capacitor having a dielectric layer including a niobium oxide layer and a niobium nitride region on the surface of the anode using niobium.

### SUMMARY OF THE INVENTION

An object of the present invention is to provide a method of producing an electrolytic capacitor being higher in capacitance, lower in leakage current, and difficult to deteriorate these properties even when a heat-treatment process such as a reflow soldering process is carried out.

The method of producing an electrolytic capacitor of the present invention comprises the steps of: forming an anode containing a valve metal; forming a dielectric layer on said anode; disposing a cathode on said dielectric layer; connecting a anode lead to said anode; connecting a cathode lead to said cathode; and forming a resin layer to cover said anode, said cathode and said dielectric layer so as to expose a part of said anode lead and a part of said cathode lead; wherein the step of forming said dielectric layer includes a step of anodizing said anode in an electrolyte solution containing hexafluoride ions at a concentration of 0.001 to 5.0% by weight (wt %).

A valve metal such as titanium, niobium, or tantalum or an alloy containing the valve metal as a main component may be used for the anode. Examples of the hexafluorides added to the electrolyte solution include ammonium salts represented by the general formula (NH₄)ₓMF₆ wherein, M represents an element selected from phosphorus, silicon, niobium, titanium, germanium, and zirconium.

In the present invention, a plate- or foil-shaped metal may be placed, as the cathode, at a position opposite to the anode. In such a case, there may be an electrolyte solution present between the anode and the dielectric layer, and the cathode.

In the invention, by forming a paste-like electrically conductive layer containing carbon and silver particles on the dielectric layer, the electrically conductive layer can be used as a cathode. In such a case, the cathode of the electrically conductive layer may be formed directly on the dielectric layer, or the cathode may be formed on the electrolyte layer containing a conductive polymer such as polypyrrole or a conductive oxide such as manganese dioxide formed on the dielectric layer.

In the method of producing an electrolytic capacitor of the aspect of invention, the electrolyte solution preferably contains at least one compound selected from ammonium hexafluorosilicate, ammonium hexafluorogermanate and ammonium hexafluorozirconate.

In the method of producing an electrolytic capacitor according to the present invention, it is possible to prepare an dielectric layer including an first dielectric layer positioned at an anode side and a second dielectric layer formed on the first dielectric layer, by anodizing the anode containing a valve metal in a hexafluoride ion-containing electrolyte solution.

The second dielectric layer positioned at a cathode side contains a metal element constructing the hexafluoride ion (M in the-General Formula) and fluorine, in addition to the valve metal and oxygen. The concentrations of oxygen and fluorine decrease in the direction from the first dielectric layer to the cathode, while the concentration of the metal element constructing the hexafluoride ion increases in the direction toward the surface.

The first dielectric layer positioned at the anode side contains almost no metal element constructing the hexafluoride ion, but the concentration of fluorine is higher than that in the second dielectric layer.

When an electrolyte solution containing at least one ammonium salt selected from ammonium hexafluorosilicate, ammonium hexafluorogermanate and ammonium hexafluorozirconate is used as the electrolyte solution, it is possible to form a second dielectric layer containing fluorine and at least one element selected from silicon, germanium and zirconium, and nitrogen.

The second dielectric layer becomes faster in the expansion/shrinkage response to heat in the area closer to the cathode where the oxygen concentration is low, and thus, even if a heat stress is applied to the dielectric layer by expansion/shrinkage of the electrolyte layer during a heat-treatment process such as a-reflow soldering process, the heat stress can be relaxed in the second dielectric layer. It is thus possible to relax the heat stress acting on the first dielectric layer and prevent cracking in the dielectric layer and increase of leakage current.

It is also possible to prevent crystallization of the second dielectric layer in the heat-treating process such as a reflow soldering process, since the second dielectric layer contains fluorine and a metal element constructing the hexafluoride ion. It is thus possible to prevent the increase of leakage current by crystallization in the dielectric layer.

Since the first dielectric layer has a fluorine concentration higher than that of the second dielectric layer, it is possible to prevent diffusion of oxygen from the dielectric layer to the anode in the heat-treating process such as a reflow soldering process. It is thus possible to prevent decrease in thickness of the dielectric layer and increase in leakage current.

As described above, the anodization of an anode containing a valve metal in a hexafluoride ion-containing electrolyte solution leads to solubilization of a part of the anode surface, leaving irregularity on the anode surface. Thus, it is possible to increase a surface area of the anode and the capacitance of the electrolytic capacitor.

When the concentration of the hexafluoride ion-containing electrolyte solution used for anodization is lower than 0.001 wt %, the fluorine concentration in the dielectric layer becomes lower, leading to deterioration of the leakage current-reducing effect. Alternatively when the concentration of the electrolyte solution is higher than 5.0 wt %, the anode is easily solubilized excessively, leading to reduction of the anode surface area and also deterioration of the capacitance-increasing effect. Accordingly, the concentration of the hexafluoride ion-containing electrolyte solution used for anodization is preferably in the range of 0.001 wt % to 5.0 wt %.

### BRIEF DESCRIPTION OF THE DRAWINGS

FIG. 1 is a cross-sectional view illustrating a solid electrolytic capacitor prepared in Experiment 1.

FIG. 2 is a chart showing the results of measuring the concentration distribution of each element in the dielectric layer formed on the anode surface of a solid electrolytic capacitor A1, in the depth direction from the surface opposite to the anode.

FIG. 3 is a schematic cross-sectional view illustrating the dielectric layer formed on the anode surface of the solid electrolytic capacitor A1.

FIG. 4 is a chart showing the results of measuring the concentration distribution of each element in the dielectric layer formed on the anode surface of a solid electrolytic capacitor X1, in the depth direction from the surface opposite to the anode.

FIG. 5 is a schematic sectional view illustrating the electrolytic capacitor prepared in Experiment 2.

### DETAILED DESCRIPTION OF THE PREFERRED EMBODIMENTS

Hereinafter, the present invention will be described more in detail with reference embodiments, but the present invention is not limited to the following embodiment at all, and any modifications within the technical scope of the present invention are also included in the present invention.

(Experiment 1)

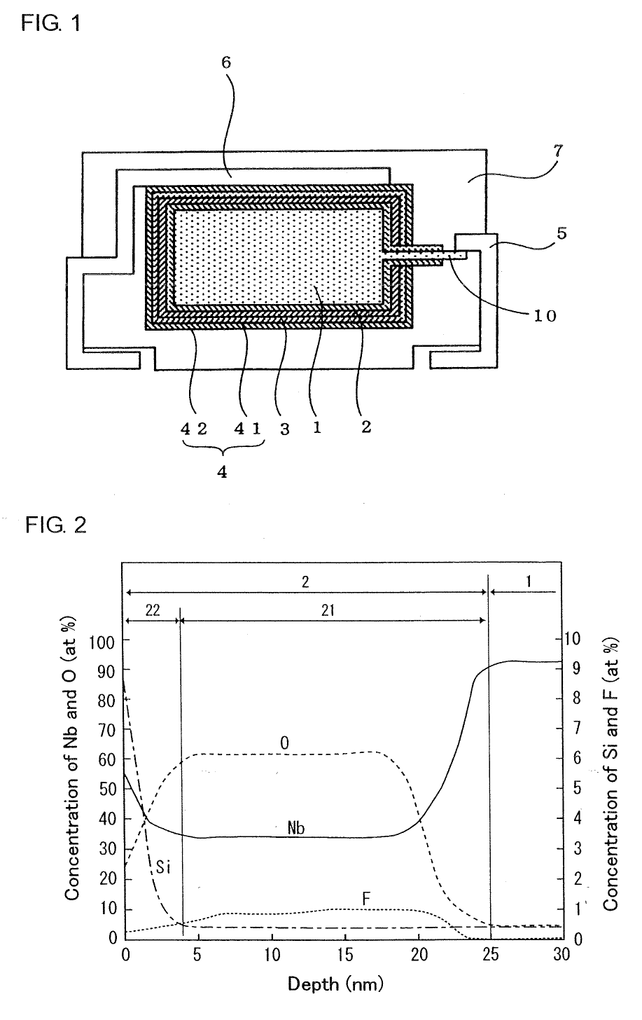

In Experiment 1, a dielectric layer was formed by anodization of an anode by using an aqueous ammonium hexafluorosilicate solution. FIG. 1 is a cross-sectional view illustrating a solid electrolytic capacitor prepared in Experiment 1. The method of producing a solid electrolytic capacitor of Experiment 1 will be described with reference to FIG. 1.

First in Experiment 1, an anode 1 made of porous sintered compact of niobium was prepared by sintering a niobium metal powder having an average particle diameter of 2 μm, and a lead wire 10 of tantalum metal was extended from the anode 1. Niobium is an example of the “valve metal” according to the present invention. 0.1 wt % aqueous-ammonium hexafluorosilicate solution was used as the electrolyte solution for anodization; a voltage of 8 V was applied between the anode 1 and the opposed electrode in the electrolyte solution heated at 60° C. for 10 hours to anodize the anode 1 and form a dielectric layer 2 on a surface of the anode 1. The aqueous ammonium hexafluorosilicate solution is an example of the “hexafluoride ion-containing electrolyte solution” according to the present invention.

As described above, an electrolyte layer 3 of polypyrrole was formed on the dielectric layer 2 on the surface of the anode 1 by chemical polymerization and so on, and a cathode 4 including a graphite layer 41 and a silver paste layer 42 was formed additionally on the electrolyte layer 3. Examples of materials for the electrolyte layer 3 include, in addition to polypyrrole described above, conductive polymeric materials such as polythiophene and polyaniline and conductive oxides such as manganese dioxide.

Then, an anode lead 5 was connected to the lead wire 10 extending from the anode 1; a cathode lead 6 was connected to the silver paste layer 42 of cathode 4; and the composite was coated with a resin layer 7 of an epoxy resin. Then, the anode lead 5 and cathode lead 6 were made to extend outward through the resin layer 7. In this way, a solid electrolytic capacitor A1 having the structure shown in FIG. 1 was prepared.

As described above, after the anodization of the anode 1, the concentration of each element in the depth direction from the surface of the dielectric layer 2, i.e., the surface opposite to the anode 1, the dielectric layer 2 formed on the surface of anode 1 was measured by energy dispersive X-ray spectroscopy (EDX), and the results are shown in FIG. 2.

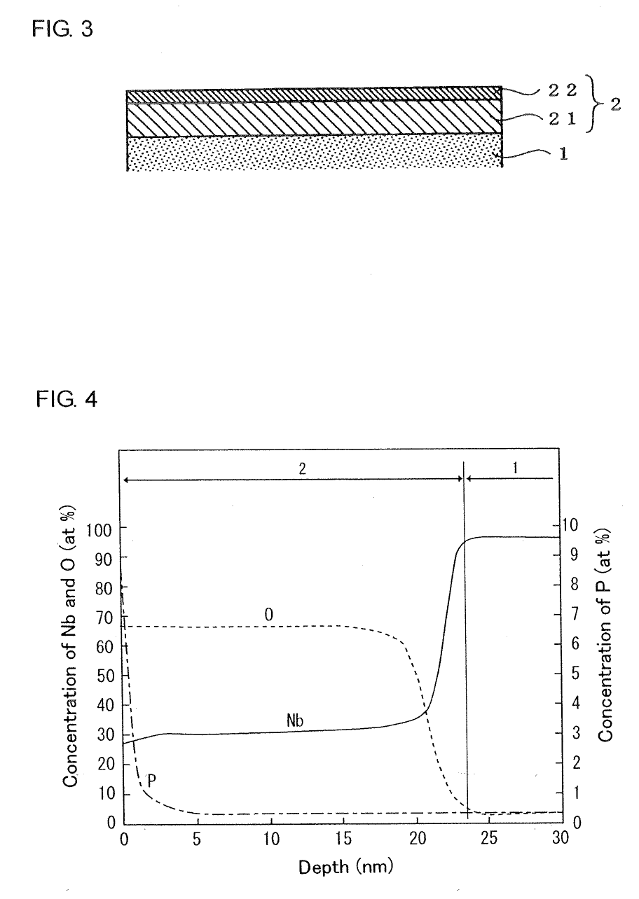

As a result, the dielectric layer 2 had a first dielectric layer 21 positioned at the surface of the anode 1 and a second dielectric layer 22 formed on the first dielectric layer 21, as schematically shown in FIG. 3. The second dielectric layer 22 has a range of approximately 4 nm in depth from the face opposite to the anode 1 and contained niobium and oxygen, as well as silicon and fluorine. Also in the second dielectric layer 22, the concentration of oxygen and fluorine decreased in the direction from the first dielectric layer 21 to the surface, while the concentration of silicon increase toward the surface.

On the other hand, the first dielectric layer 21 having a depth from the surface of the dielectric layer 2 in the range of approximately 4 nm to approximately 25 nm contained almost no silicon. The concentration of fluorine in the first dielectric layer 21 is higher than that in the second dielectric layer 22. The concentration of oxygen decreased at a depth of more than approximately 17 nm from the surface of the dielectric layer 2, while the concentration of niobium increased.

After the anodization of the anode 1, the surface state of the dielectric layer 2 formed on the surface of the anode 1 was observed under a scanning electron microscope (SEM). The results showed that the surface of the dielectric layer 2 had fine irregularity formed thereon and a surface area increased.

Then, solid electrolytic capacitors A2 to A12 were prepared in a similar manner to the solid electrolytic capacitor A1, except that the dielectric layer 2 was formed on the surface of the anode 1 by performing anodization by using an aqueous ammonium hexafluorosilicate solution at a concentration of 0.0005 wt %, 0.0007 wt %, 0.001 wt %, 0.005 wt %, 0.01 wt %, 0.05 wt %, 0.5 wt %, 1.0 wt %, 5.0 wt %, 7.0 wt %, or 10.0 wt %, instead of the electrolyte solution for the anodization of 0.1 wt % aqueous ammonium hexafluorosilicate solution.

In addition, a solid electrolytic capacitor A13 was prepared in a similar manner to the solid electrolytic capacitor A1, except that a porous titanium sintered compact prepared by sintering a niobium-aluminum alloy powder containing 0.5 wt % aluminum having an average particle diameter of 2 μm was used as the anode 1 instead of the anode 1 prepared by sintering the niobium metal powder having an average particle diameter of 2 μm.

Further, a solid electrolytic capacitor B1 was prepared in a similar manner to the solid electrolytic capacitor A1, except that a porous sintered compact of titanium prepared by sintering a titanium metal powder having an average particle diameter of 2 μm was used as the anode 1 instead of the anode 1 prepared by sintering a niobium metal powder having an average particle diameter of 2 μm. The titanium is an example of the “valve metal” according to the present invention.

The concentration of each element in the depth direction from the surface of the dielectric layer 2, i.e., the face opposite to the anode 1, of the solid electrolytic capacitors A2 to A13 and B1 was determined by EDX, similarly to the solid electrolytic capacitor A1. The results showed that the capacitors had, similarly to the solid electrolytic capacitor A1, a first dielectric layer 21 placed on the surface of the anode 1 and a second dielectric layer 22 formed on the first dielectric layer 21. In the second dielectric layer 22, the oxygen concentration decreased in the direction from the first dielectric layer 21 to the surface, while silicon and fluorine are present, and the silicon concentration increased in the direction toward the surface. The first dielectric layer 21 contained almost no silicon, and the fluorine concentration in the first dielectric layer 21 was higher than that in the second dielectric layer 22.

Then in a comparative experiment, a solid electrolytic capacitor X1 was prepared in a similar manner to the solid electrolytic capacitor A1, except that the anodization of the anode 1 was performed in 0.1 wt % aqueous phosphate solution instead of 0.1 wt % aqueous ammonium hexafluorosilicate solution.

In addition, a solid electrolytic capacitor Y1 was prepared in a similar manner to the solid electrolytic capacitor B1, except that the anodization of the anode 1 was performed in 0.1 wt % aqueous phosphate solution instead of 0.1 wt % aqueous ammonium hexafluorosilicate solution.

The concentration of each element in the depth direction from the surface of the dielectric layer 2, i.e., from the face opposite to the anode 1, of the dielectric layers 2 in the solid electrolytic capacitors X1 and Y1 was determined, similarly to the solid electrolytic capacitor A1 by EDX. FIG. 4 is a chart showing the results of measuring the concentration of each element in the dielectric layer 2 formed on the surface of the anode 1 of solid electrolytic capacitor X1 in the depth direction from the surface opposite to the anode 1.

As shown in FIG. 4, the dielectric layer 2 in solid electrolytic capacitor X1 contained phosphorus at a depth in the range from the surface to approximately 4 nm in depth, but contained no silicon or fluorine therein, differently from the dielectric layer 2 of the solid electrolytic capacitor A1. The dielectric layer 2 of the solid electrolytic capacitor X1 contained oxygen and niobium at the same concentrations in the range from the surface to approximately 2 to 17 nm in depth, but did not show decrease of oxygen concentration in the surface side of the dielectric layer 2, as the dielectric layer 2 of the solid electrolytic capacitor A1. The dielectric layer 2 of the solid electrolytic capacitor Y1 gave analytical results similar to those of the dielectric-layer 2 of the solid electrolytic capacitor X1.

After the anodization of anode 1 of the solid electrolytic capacitor X1 the surface state of the dielectric layer 2 formed on the surface of the anode 1 was observed under SEM. The results showed that the surface of the dielectric layer 2 did not have microirregularity, which was observed on the solid electrolytic capacitor A1.

(Evaluation 1)

Subsequently, the leakage current of each of the solid electrolytic capacitors A1 to A13, B1, X1 or Y1 thus obtained during reflow soldering process was determined.

The reflow soldering process of each solid electrolytic capacitor was performed under heat in an air reflow system at a peak temperature of 240° C. for 5 minutes; a voltage of 5 V was applied to each solid electrolytic capacitor after reflow soldering process and the leakage current after 20 seconds was measured; and the results are summarized in Table 1.

As described above, the capacitance of each solid electrolytic capacitor after reflow soldering process at a frequency of 120 Hz was measured, and the results are summarized in Table 1. The fluorine concentrations in the first dielectric layer 21 and the second-dielectric layer 22 are also shown in Table 1. The fluorine concentration in the first dielectric layer 21 shown is an average fluorine concentration, while that of the second dielectric layer 22 is the maximum fluorine concentration.

TABLE 1

| | Concentration of | Fluorine Concentration (at %) | | | Leakage |
|---|---|---|---|---|---|
| | Electrolyte Solution | First Dielectric | Second Dielectric | Capacitance | Current |
| | (wt %) | Layer | Layer | (μF) | (μA) |
| A2 | 0.0005 | 0.005 | 0.005 | 300 | 600 |
| A3 | 0.0007 | 0.008 | 0.008 | 305 | 300 |
| A4 | 0.001 | 0.01 | 0.01 | 330 | 80 |
| A5 | 0.005 | 0.05 | 0.04 | 335 | 40 |
| A6 | 0.01 | 0.1 | 0.07 | 340 | 30 |
| A7 | 0.05 | 0.5 | 0.28 | 345 | 30 |
| A1 | 0.1 | 1.0 | 0.5 | 350 | 20 |
| A8 | 0.5 | 1.5 | 0.64 | 360 | 20 |
| A9 | 1.0 | 2.5 | 0.70 | 360 | 30 |
| A10 | 5.0 | 5.0 | 0.75 | 360 | 60 |
| A11 | 7.0 | 5.5 | 0.8 | 310 | 250 |
| A12 | 10.0 | 5.8 | 0.85 | 305 | 500 |
| A13 | 0.1 | 1.0 | 0.5 | 360 | 18 |
| B1 | 0.1 | 1.0 | 0.5 | 500 | 500 |
| X1 | 0.1 | — | — | 280 | 800 |
| Y1 | 0.1 | — | — | 350 | 2000 |

By comparing each of the solid electrolytic capacitors A1 to A13 with X1 or B1 with Y1 in Table 1, it is obvious that the solid electrolytic capacitors A1 to A13 and B1, which was anodized in an electrolyte solution of an aqueous ammonium hexafluorosilicate solution, had a capacitance higher and a leakage current lower than those of the solid electrolytic capacitors X1 and Y1 anodized in an electrolyte solution of an aqueous phosphate solution, independently of whether the anode 1 is niobium or titanium.

Table 1 also shows that when the concentration of the aqueous ammonium hexafluorosilicate solution is in the range of 0.001 wt % to 5.0 wt %, the increase in capacitance and the decrease in leakage current are significant. It also shows that the concentration of the aqueous ammonium hexafluorosilicate solution is more preferably in the range of 0.01 wt % to 5.0 wt % for increase of capacitance, while the concentration of the aqueous ammonium hexafluorosilicate solution is more preferably in the range of 0.01 wt % to 1.0 wt % for decrease of leakage current.

(Experiment 2)

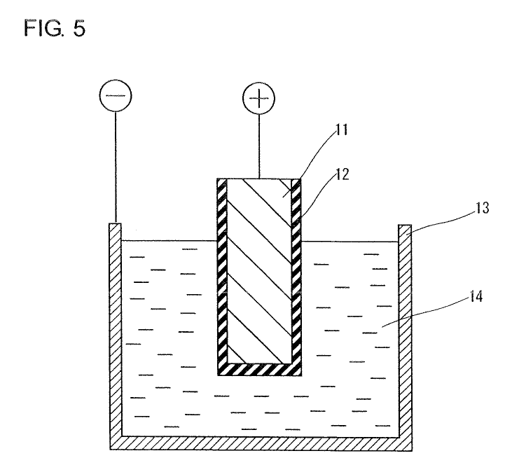

In Experiment 2, anodization was performed by using an aqueous ammonium hexafluorogermanate solution, to form a dielectric layer. FIG. 5 is a schematic cross-sectional view illustrating the electrolytic capacitor prepared in Experiment 2. The method of producing the electrolytic capacitor of Experiment 2 will be described, with reference to FIG. 5.

In Experiment 2, an anode 11 of a niobium metal foil having a thickness of 0.1 mm was prepared. The anode 11 was anodized by using 0.0005 wt % aqueous ammonium hexafluorogermanate solution as the electrolyte solution, to form a dielectric layer 12 on the surface of the anode 11. The temperature of the aqueous ammonium hexafluorogermanate solution then was 60° C., the voltage applied between the anode 11 and the opposed electrode, 10 V, and the anodization period, 30 minutes. The aqueous ammonium hexafluorogermanate solution is an example of the “hexafluoride ion-containing electrolyte solution” according to the present invention.

The anode 11 and dielectric layer 12 prepared above were immersed in an electrolyte solution 14 contained in a stainless steel container 13, to give an electrolytic capacitor C1.

In addition, electrolytic capacitors C2 to C13 were prepared in a similar manner to the electrolytic capacitor C1, except that the anode 11 was anodized by using an aqueous ammonium hexafluorogermanate solution at a concentration of 0.0007 wt %, 0.001 wt %, 0.005 wt %, 0.01 wt %, 0.05 wt %, 0.1 wt %, 0.5 wt %, 1.0 wt %, 2.5 wt %, 5.0 wt %, 7.0 wt %, or 10.0 wt % instead of the 0.0005 wt % aqueous ammonium hexafluorogermanate solution, forming a dielectric layer 12 on the surface of the anode 11.

In a comparative experiment, a solid electrolytic capacitor Z1 was prepared in a similar manner to the electrolytic capacitor C1, except that the anode 11 was anodized in 0.1 wt % aqueous phosphate solution instead of 0.0005 wt % aqueous ammonium hexafluorogermanate solution.

The concentration of each element in the depth direction from the surface of the dielectric layer 2, i.e., from the face opposite to the anode 1 of the dielectric layers 2 in the solid electrolytic capacitors C1 to C13 was determined similarly to the solid electrolytic capacitor A1 by EDX. As a result, similarly to the solid electrolytic capacitor A1, the dielectric layer 12 had a first dielectric layer placed on the surface of the anode 11 and a second dielectric layer formed on the first dielectric layer. In the second dielectric layer, the oxygen concentration decreased in the direction from the first dielectric layer to the surface; the layer contained germanium and fluorine, and the concentration of germanium increased in the direction toward the surface. The first dielectric layer contained almost no germanium, and the fluorine concentration in the first dielectric layer was found to be higher than that in the second dielectric layer.

(Evaluation 2)

Subsequently, the leakage current and the capacitance of each of the electrolytic capacitors C2 to C13 and Z1 thus prepared were determined.

The leakage current of each electrolytic capacitor was determined by using 0.5 wt % aqueous phosphate solution kept at 60° C. as the electrolyte solution 14, applying a voltage of 3.3 V between the anode 1 and a container 13 made of stainless steel, and measuring the current after 5 seconds. The capacitance of each electrolytic capacitor was determined by using 30 wt % aqueous sulfate solution kept at 25° C. as the electrolyte solution 14 and measuring the capacitance at a frequency of 120 Hz. Results are summarized in Table 2. Shown in Table 2 are the leakage current and the capacitance of each electrolytic capacitor, as determined by dividing the measured value by the surface area of the dielectric layer 12, which was immersed in the electrolyte solution 14.

Te fluorine concentrations contained in the first and second dielectric layers, as determined by EDX as above, are also shown in Table 2. The fluorine concentration in each layer of the first dielectric layer is an average fluorine concentration, while that of the second dielectric layer is the maximum fluorine concentration.

TABLE 2

| | Concentration of | Fluorine Concentration (at %) | | | Leakage |
|---|---|---|---|---|---|
| | Electrolyte Solution | First Dielectric | Second Dielectric | Capacitance | Current |
| | (wt %) | Layer | Layer | (μF/cm²) | (μA/cm²) |
| C1 | 0.0005 | 0.007 | 0.005 | 0.80 | 21.0 |
| C2 | 0.0007 | 0.009 | 0.008 | 0.88 | 11.3 |
| C3 | 0.001 | 0.15 | 0.01 | 1.05 | 2.9 |
| C4 | 0.005 | 0.65 | 0.015 | 1.06 | 2.6 |
| C5 | 0.01 | 1.10 | 0.02 | 1.11 | 2.0 |
| C6 | 0.05 | 1.70 | 0.05 | 1.26 | 1.3 |
| C7 | 0.1 | 1.73 | 0.06 | 1.68 | 1.2 |
| C8 | 0.5 | 1.80 | 0.09 | 1.72 | 1.2 |
| C9 | 1.0 | 1.83 | 0.10 | 1.70 | 1.2 |
| C10 | 2.5 | 2.08 | 0.60 | 1.71 | 1.2 |
| C11 | 5.0 | 4.98 | 0.75 | 1.58 | 2.0 |
| C12 | 7.5 | 5.75 | 0.85 | 1.00 | 10.0 |
| C13 | 10.0 | 6.10 | 1.00 | 0.85 | 13.8 |
| Z1 | 0.1 | — | — | 1.04 | 35.0 |

As shown in Table 2, the leakage current of any electrolytic capacitors C1 to C13 was smaller than that of the electrolytic capacitor Z1. The leakage current of each of the electrolytic capacitors C3 to C11, which was processed in an aqueous ammonium hexafluorogermanate solution for anodization at a concentration in the range of 0.001 wt % to 5.0 wt %, was smaller and the capacitance thereof higher than those of the electrolytic capacitor Z1. In particular, the electrolytic capacitors C5 to C11, which were processed in an aqueous ammonium hexafluorogermanate solution at a concentration in the range of 0.01 wt % to 5.0 wt %, had a leakage current significantly smaller and a capacitance significantly higher than those of the electrolytic capacitor Z1.

(Experiment 3)

In Experiment 3, solid electrolytic capacitors having a configuration similar to that in Experiment 1 were prepared by forming a dielectric layer by the anodization of the anode by using an aqueous ammonium hexafluorogermanate solution or an aqueous ammonium hexafluorozirconate solution.

First, a solid electrolytic capacitor D1 was prepared in a similar manner to the solid electrolytic capacitor A1, except that a dielectric layer 2 was formed on the surface of anode 1 by anodizing anode 1 by using 0.1 wt % aqueous ammonium hexafluorogermanate solution instead of 0.1 wt % aqueous ammonium hexafluorosilicate solution as the electrolyte solution for anodization.

The concentration of each element in the dielectric layer 2 of solid electrolytic capacitor D1 in the depth direction from the surface of the dielectric layer 2, i.e., the surface opposite to the anode 1, was determined by EDX, similarly to the solid electrolytic capacitor A1. The results showed that the dielectric layer 2 had the first dielectric layer 21 positioned on the surface of the anode 1 and a second dielectric layer 22 formed on the first dielectric layer similarly to the solid electrolytic capacitor A1. The second dielectric layer contained oxygen of which the concentration decreased in the direction from the first dielectric layer 21 to the surface, and germanium and fluorine, and the concentration of germanium increased in the direction toward the surface. The first dielectric layer 21 contained almost no germanium, and the fluorine concentration in the first dielectric layer 21 was found to be higher than that in the second dielectric layer 22.

A solid electrolytic capacitor D2 was prepared in a similar manner to the solid electrolytic capacitor A1, except that a dielectric layer 2 was formed on the surface of the anode 1 by using 0.1 wt % aqueous ammonium hexafluorozirconate solution instead of 0.1 wt % aqueous ammonium hexafluorosilicate solution as the electrolyte solution for anodization by anodizing the anode 1. The aqueous ammonium hexafluorozirconate solution is an example of the “hexafluoride ion-containing electrolyte solution” according to the present invention.

The concentration of each element in the depth direction from the surface of the dielectric layer 2, i.e., from the face opposite to the anode 1, of the dielectric layers 2 in the solid electrolytic capacitor D2 was also determined similarly to the solid electrolytic capacitor A1 by EDX. The results showed that the dielectric layer had a first dielectric layer 21 formed on the surface of the anode 1 position and a second dielectric layer 22 formed on the first dielectric layer 21 similarly to the solid electrolytic capacitor A1. The second dielectric layer 22 contained oxygen, of which the concentration decreased in the direction from the first dielectric layer 21 to the surface, and the layer also contained germanium and fluorine, and the concentration of germanium increased in the direction toward the surface. The first dielectric layer 21 contained almost no germanium, and the fluorine concentration in the first dielectric layer 21 was found to be higher than that in the second dielectric layer 22.

(Evaluation 3)

Subsequently, the leakage current and the capacitance of each electrolytic capacitor D1 and D2 thus prepared were determined.

The reflow soldering process of each solid electrolytic capacitor was performed under heat in an air reflow system at a peak temperature of 240° C. for 5 minutes; a voltage of 5 V was applied to each solid electrolytic capacitor after reflow soldering process, and the leakage current after 20 seconds was measured; and the results are summarized in Table 3.

As described above the capacitance of each individual electrolytic capacitor after reflow soldering process at a frequency of 120 Hz was measured, and the results are summarized in Table3. The fluorine concentrations in the first dielectric layer 21 and the second dielectric layer 22 are also shown in Table 1. The fluorine concentration in the first dielectric layer 21 is an average fluorine concentration, while that of the second dielectric layer 22 is the maximum fluorine concentration.

TABLE 3

| | Fluorine Concentration (at %) | | | Leakage |
|---|---|---|---|---|
| | First | Second | Capacitance | Current |
| | Dielectric Layer | Dielectric Layer | (μF) | (μA) |
| D1 | 1.0 | 0.5 | 370 | 22 |
| D2 | 1.0 | 0.5 | 330 | 23 |
| A1 | 1.0 | 0.5 | 350 | 20 |

As shown in Table 3, the electrostatic capacitance and the leakage current of each of the solid electrolytic capacitors D1 and D2 was similar to those of the solid electrolytic capacitor A1, and the capacitance was larger but the leakage current was smaller than those of solid electrolytic capacitor X1.

What is claimed is:

1. A method of producing an electrolytic capacitor, comprising the steps of:
forming an anode containing a valve metal;
forming a dielectric layer on said anode;
disposing a cathode on said dielectric layer;
connecting a anode lead to said anode;
connecting a cathode lead to said cathode; and
forming a resin layer to cover said anode, said cathode and said dielectric layer so as to expose a part of said anode lead and a part of said cathode lead;
wherein the step of forming said dielectric layer includes a step of anodizing said anode in an electrolyte solution containing hexafluoride ions at a concentration of 0.001 to 5.0% by weight.

2. The method of producing an electrolytic capacitor according to claim 1, wherein the electrolyte solution contains at least one compound selected from a group consisting of ammonium hexafluorosilicate, ammonium hexafluorogermanate and ammonium hexafluorozirconate.
